(19) United States
(12) Patent Application Publication
(10) Pub. No.: US 2010/0254116 A1
(43) Pub. Date: Oct. 7, 2010

(54) LIGHTING APPARATUS AND REFRIGERATOR HAVING THE SAME

(75) Inventor: Bong-Kook Lee, Gyeongsangnam-Do (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 12/740,379

(22) PCT Filed: Oct. 23, 2008
(86) PCT No.: PCT/KR2008/006265

§ 371 Date: Apr. 29, 2010

(30) Foreign Application Priority Data
Oct. 30, 2007 (KR) 10-2007-0109836

(51) Int. Cl. F25D 23/02; F21S 4/00

(52) U.S. Cl. 362/92; 362/249.01

(57) ABSTRACT

Disclosed are a lighting apparatus and a refrigerator having the same. The lighting apparatus comprises: a lighting module having one or more light emitting devices, and having a circuit board to make the one or more light emitting devices emit light; and a waterproofing unit for protecting the lighting module from moisture. Accordingly, the lighting module is protected from moisture, and entire fabrication processes are simplified. Furthermore, light emitting efficiency is prevented from being degraded.

### TECHNICAL FIELD

The present invention relates to a lighting apparatus and a refrigerator having the same, and particularly, to a lighting apparatus capable of protecting a lighting module from moisture, and a refrigerator having the same.

### BACKGROUND ART

Generally, a refrigerator serves to maintain food items with a low temperature status in cooling chambers. The refrigerator comprises a refrigerator body having cooling chambers therein, doors configured to open and close the cooling chambers, and a refrigeration cycle for providing cool air to the cooling chambers. As the refrigeration cycle, mainly used is a vapor-compression refrigeration cycle including a compressor to compress a refrigerant, a condenser to condense the compressed refrigerant, an expander to expand the condensed refrigerant, and an evaporator to absorb and evaporate peripheral latent heat.

A lighting module for lightening inside of the cooling chambers is provided in the refrigerator.

The lighting module is provided with one or more light emitting devices configured to emit light so as to lighten inside of the refrigerator when the refrigerator is opened.

The one or more light emitting devices are configured to allow a user to easily recognize inside of the refrigerator when the door of the refrigerator is opened. Here, the one or more light emitting devices may be configured so as to stop emitting light when the door is closed.

Humidity or water (hereinafter, will be referred to as ‘moisture’) exists in the refrigerator, which may cause the lighting module in the refrigerator to be corroded or to have a short circuit.

### DISCLOSURE OF INVENTION

### Technical Problem

Therefore, an object of the present invention is to provide a lighting apparatus capable of protecting a lighting module from moisture, and a refrigerator having the same.

Another object of the present invention is to provide a lighting apparatus capable of protecting a lighting module from moisture and capable of simplifying fabrication processes, and a refrigerator having the same.

Still another object of the present invention is to provide a lighting apparatus capable of protecting a lighting module from moisture, capable of simplifying fabrication processes, and capable of preventing light emitting efficiency from lowering, and a refrigerator having the same.

### Technical Solution

To achieve these and other advantages and in accordance with the purpose of the present invention, as embodied and broadly described herein, there is provided a lighting apparatus, comprising: a lighting module having one or more light emitting devices, and having a circuit board to make the one or more light emitting devices emit light; and a waterproofing unit for protecting the lighting module from moisture.

Here, the waterproofing unit may be constituted with a waterproofing material that covers the lighting module.

Here, the waterproofing material may be composed of silicone.

The waterproofing material may be deposited onto the circuit board so that the one or more light emitting devices are exposed out.

The one or more light emitting diodes may be implemented as one or more light emitting diodes (LED).

The waterproofing unit may be configured as a waterproofing structure to insert the lighting module therein.

The waterproofing structure may include a case having an accommodation space therein, and a cover configured to hermetically seal the case.

The case may be provided with a transparent window.

The case may be formed of a transparent material.

To achieve these and other advantages and in accordance with the purpose of the present invention, as embodied and broadly described herein, there is also provided a refrigerator, comprising: a refrigerator body having a cooling chamber therein; a door configured to open and close the cooling chamber; and a lighting apparatus disposed in the cooling chamber.

According to another aspect of the present invention, there is provided a refrigerator comprising: a refrigerator body having a cooling chamber therein; a door configured to open and close the cooling chamber; and a lighting apparatus, wherein the lighting apparatus includes a lighting module having one or more light emitting devices, and having a circuit board to make the one or more light emitting devices emit light; and a waterproofing structure configured to accommodate the lighting module therein.

### Advantageous Effects

As aforementioned, in the present invention, the waterproofing unit is formed by depositing a waterproofing material such as silicone on the surface of the circuit board so that the one or more light emitting devices can be exposed out. Accordingly, the lighting module can be effectively protected from moisture, and can be prevented a light scattering phenomenon that may occur as the one or more light emitting devices and the circuit board are covered with the waterproofing material.

Furthermore, the waterproofing unit is formed by depositing a transparent water-proofing material on the surface of the lighting module, thereby simplifying fabrication processes and requiring no expensive installations.

In the lighting apparatus of the present invention, the lighting module is protected from moisture without degrading its capability to emit light. This enhances high industrial applicability.

### BRIEF DESCRIPTION OF THE DRAWINGS

In the drawings:

FIG. 1 is a perspective view showing a refrigerator having a lighting apparatus according to a first embodiment of the present invention;

FIG. 2 is a longitudinal sectional view showing the lighting apparatus of the refrigerator of FIG. 1;

FIG. 3 is a sectional view showing a refrigerator having a lighting apparatus according to a second embodiment of the present invention;

FIG. 4 is a sectional view showing a waterproofing structure of FIG. 3;

FIG. 5 is a modification example of the waterproofing structure of FIGS. 3; and

FIG. 6 is a side sectional view showing a lighting apparatus according to a third embodiment of the present invention, which is applied to a refrigerator.

### MODE FOR THE INVENTION

Reference will now be made in detail to embodiments of the present disclosure, examples of which are illustrated in the accompanying drawings.

Hereinafter, a lighting apparatus and a refrigerator having the same according to the present invention will be explained in more detail.

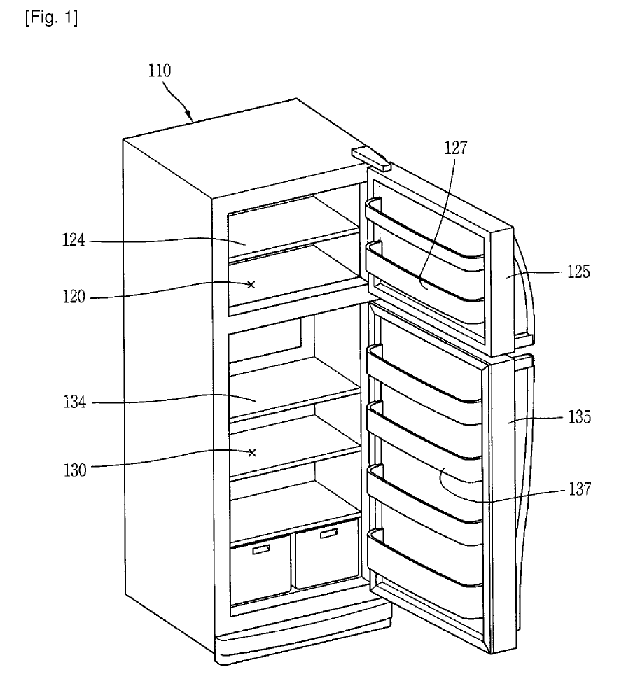

As shown in FIG. 1, a refrigerator having a lighting apparatus according to a first embodiment comprises a refrigerator body 110 having cooling chambers 120 and 130 therein, a freezing chamber door 125 and a refrigerating chamber door 135 configured to open and close the cooling chambers 120 and 130, and a lighting apparatus 140 disposed in the cooling chambers 120 and 130 so as to lighten the cooling chambers 120 and 130.

Here, the cooling chambers 120 and 130 totally indicate a freezing chamber and a refrigerating chamber, and the refrigerator body 110 may be provided with only one of the freezing chamber and the refrigerating chamber. Here, the refrigerator body 110 is implemented as a so-called top freezer type of refrigerator that a freezing chamber is disposed at an upper side of a refrigerating chamber in an upper and lower direction of the refrigerator body 110. However, the refrigerator body 110 may be implemented as a bottom freezer type of refrigerator that a freezing chamber is disposed at a lower side of a refrigerating chamber. Also, the refrigerator body 110 may be implemented as a side by side type of refrigerator that a freezing chamber and a refrigerating chamber are disposed at right and left sides.

The freezing chamber 120 is formed at an upper region of the refrigerator body 110, and the refrigerating chamber 130 is formed at a lower region of the refrigerator body 110. The freezing chamber door 125 and the refrigerating chamber door 135 configured to open and close the freezing chamber 120 and the refrigerating chamber 130, respectively are provided on front surfaces of the freezing chamber 120 and the refrigerating chamber 130. A refrigeration cycle (not shown) is provided at the refrigerator body 110 so that cool air can be supplied to the freezing chamber 120 and the refrigerating chamber 130.

Shelves 124 and 134 for efficiently receiving food items therein are provided in the freezing chamber 120 and the refrigerating chamber 130, respectively. A plurality of door pockets 127 and 137 for receiving food items therein are provided at the freezing chamber door 125 and the refrigerating chamber door 135.

The lighting apparatus 140 for lightening the freezing chamber 120 and the refrigerating chamber 130 when the freezing chamber 120 and the refrigerating chamber 130 are opened are provided inside the freezing chamber 120 and the refrigerating chamber 130, respectively. The lighting apparatus 140 may be installed on each ceiling of the freezing chamber 120 and the refrigerating chamber 130 so as to protect a user from dazzling and to prevent light emitting efficiency from lowering. The installation position of the lighting apparatus 140 is merely exemplary, and may be varied.

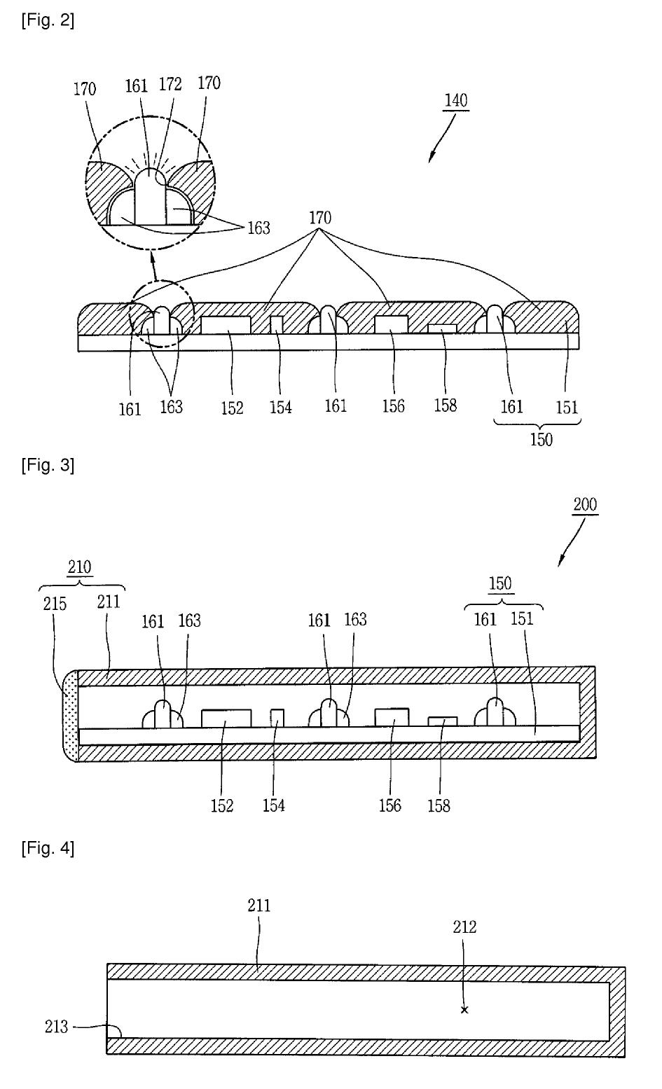

As shown in FIG. 2, the lighting apparatus 140 includes a lighting module 150 having one or more light emitting devices 161, and having a circuit board 151 to make the one or more light emitting devices 161 emit light; and a waterproofing unit 170 for protecting the lighting module 150 from moisture.

The one or more light emitting devices 161 may be configured so as to emit light by the circuit board 151, when the freezing chamber 120 and the refrigerating chamber 130 are opened by the freezing chamber door 125 and the refrigerating chamber door 135. Here, as the one or more light emitting devices 161, one or more light emitting diodes (LED) may be used.

The circuit board 151 may be constituted with components to make the one or more light emitting devices 161 emit light, such as a microprocessor 152, a resistor 154, an integrated circuit (IC) 156, and a capacitor 158. A plurality of the light emitting devices 161 may be mounted on the circuit board 151 by an adhering means 163 such as a solder.

The waterproofing unit 170 for protecting each circuit component of the lighting module 150 from moisture is provided on the surface of the lighting module 150. The waterproofing unit 170 may be implemented by depositing a waterproofing material on the surface of the lighting module 150. More concretely, the lighting module 150 is protected from moisture inside the freezing chamber 120 or the refrigerating chamber 130 as a waterproofing material deposited on its surface serves as the waterproofing unit 170. The lighting module 150 is protected from external moisture inside the freezing chamber 120 and/or the refrigerating chamber 130, thereby preventing corrosions of electric patterns thereof or mal-operations or degraded performances due to short circuit. This may enhance reliability of the product.

Here, the waterproofing material may be silicone. The waterproofing material is deposited onto the lighting module 150 by an additional dispenser (not shown), and then is hardened for a predetermined time, thereby waterproofing the lighting module 150 in a covering manner.

The waterproofing unit 170 may be configured so that some parts of the light emitting devices 161 can be exposed out. That is, the waterproofing unit 170 may be provided with holes 172 so that the light emitting devices 161 can be exposed out therethrough. The holes 172 may be formed not by depositing the waterproofing material on the light emitting devices 161, especially, on a part from which light is emitted, when the waterproofing material is deposited on the circuit board 151. Here, inner surfaces of the holes 172 are adhered to outer surfaces of the light emitting devices 161, thereby preventing external moisture from being introduced into the light emitting devices 161 through the holes 172.

Since the waterproofing material, the waterproofing unit 170 is provided with the holes 172 through which the light emitting devices 161 is exposed out, can be prevented a light scattering phenomenon that may occur as the one or more light emitting devices 161 and the circuit board 151 are covered with the waterproofing material. This protects the lighting module 150 from moisture, and prevents light emitting efficiency of the lighting module 150 from lowering.

Hereinafter, with reference to FIGS. 3 and 4, will be explained a refrigerator having a lighting apparatus according to a second embodiment of the present invention. The same or similar reference numerals will be given to the same or similar parts as/to those of the aforementioned embodiment, and their detailed explanations will be omitted.

As shown in FIGS. 3 and 4, a refrigerator having a lighting apparatus according to a second embodiment comprises a refrigerator body 110 having a freezing chamber 120 and a refrigerating chamber 130 therein, a freezing chamber door 125 and a refrigerating chamber door 135 configured to open and close the freezing chamber 120 and the refrigerating chamber 130, respectively, and a lighting apparatus 200 disposed in the freezing chamber 120 and the refrigerating chamber 130 so as to lighten the freezing chamber 120 and the refrigerating chamber 130.

The lighting apparatus 200 includes a lighting module 150 having one or more light emitting devices 161, and a circuit board 151 to make the one or more light emitting devices 161 emit light; and a waterproofing unit 210 for protecting the lighting module 150 from moisture. The circuit board 151 may be constituted with components to make the one or more light emitting devices 161 emit light, such as a microprocessor 152, a resistor 154, an integrated circuit (IC) 156, and a capacitor 158.

The waterproofing unit 210 may be composed of a waterproofing structure 211 for accommodating the lighting module 150 therein and protecting the lighting module 150 from external moisture.

The waterproofing structure 211 may be provided with an accommodation space 212 for accommodating the lighting module 150 therein, and may be provided with an opening 213 at one side thereof. The waterproofing structure 211 may be formed of a transparent material, and may be formed of a synthetic resin or silicone, etc. Here, the waterproofing structure 211 may be configured to have a structure to insert and fix the lighting module 150. The waterproofing structure 211 may be further provided with a hermetic portion 215 formed by depositing silicone to the opening 213 after the lighting module 150 has been accommodated in the accommodation space 212. Accordingly, the lighting module 150 inside the waterproofing structure 211 can be protected from external moisture.

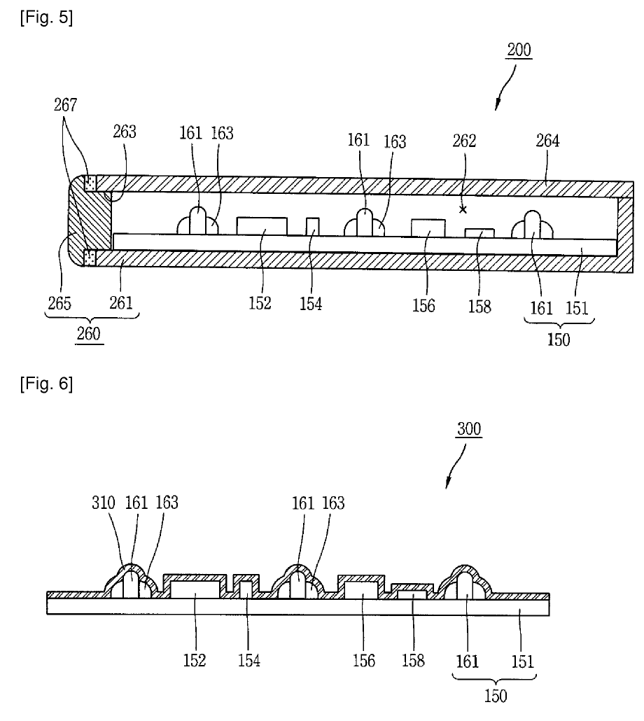

As shown in FIG. 5, the waterproofing unit 260 may include a case 261 having an accommodation space 262 implemented as the waterproofing unit 260 has an opening 263 at one side so as to accommodate the lighting module 150 therein; and a cover 265 configured to cover the opening 263 of the case 261.

The case 261 may be provided with a transparent window 264 for transmitting light emitted from the one or more light emitting devices 161 therethrough. The transparent window 264 may have a controllable size. The case 261 may be entirely formed of a transparent material, and the cover 265 may be formed of a transparent material.

The waterproofing unit 260 may be further provided with a hermetic portion 267 formed by depositing a waterproofing material such as silicone to a coupling region between the case 261 and the cover 265. This more prevents external moisture from being introduced into the lighting module 150, thereby effectively protecting the lighting module 150 from moisture.

Hereinafter, a refrigerator having a lighting apparatus according to a third embodiment will be explained in more detail with reference to FIG. 6.

As shown in FIG. 6, a refrigerator having a lighting apparatus according to a third embodiment comprises a refrigerator body 110 having cooling chambers 120 and 130 therein, a freezing chamber door 125 and a refrigerating chamber door 135 configured to open and close the cooling chambers 120 and 130, and a lighting apparatus 300 disposed in the cooling chambers 120 and 130 so as to lighten the cooling chambers 120 and 130.

The lighting apparatus 300 includes a lighting module 150 having one or more light emitting devices 161, and having a circuit board 151 to make the one or more light emitting devices 161 emit light; and a waterproofing unit 310 for protecting the lighting module 150 from moisture.

The circuit board 151 may be constituted with components to make the one or more light emitting devices 161 emit light, such as a microprocessor 152, a resistor 154, an integrated circuit (IC) 156, and a capacitor 158.

The waterproofing unit 310 may be implemented by depositing a waterproofing material on the surface of the lighting module 150. The waterproofing material may be silicone formed of a transparent material, and may be coated on both an outer surface and an inner surface of the circuit board 151. This protects the lighting module 150 from moisture, and prevents light emitting efficiency of the lighting module 150 from lowering.

Furthermore, the waterproofing unit 310 is formed by coating the waterproofing material, thereby simplifying fabrication processes and requiring no expensive installations.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. A lighting apparatus, comprising:
a lighting module having one or more light emitting devices, and having a circuit board to make the one or more light emitting devices emit light; and
a waterproofing unit for protecting the lighting module from moisture.

2. The lighting apparatus of claim 1, wherein the waterproofing unit is constituted with a waterproofing material that covers the lighting module.

3. The lighting apparatus of claim 2, wherein the waterproofing material is composed of silicone.

4. The lighting apparatus of claim 3, wherein the waterproofing material is deposited onto the circuit board such that the one or more light emitting devices are exposed out.

5. The lighting apparatus of claim 1, wherein the one or more light emitting diodes are implemented as one or more light emitting diodes (LED).

6. The lighting apparatus of claim 1, wherein the waterproofing unit is configured as a waterproofing structure to insert the lighting module therein.

7. The lighting apparatus of claim 6, wherein the waterproofing structure comprises:
a case having an accommodation space therein; and
a cover configured to hermetically seal the case.

8. The lighting apparatus of claim 7, wherein the case is provided with a transparent window.

9. The lighting apparatus of claim 7, wherein the case is formed of a transparent material.

10. A refrigerator having a lighting apparatus, comprising:
a refrigerator body having a cooling chamber therein;
a door configured to open and close the cooling chamber; and
the lighting apparatus of claim 1 disposed in the cooling chamber.

11. A refrigerator having a lighting apparatus, comprising:
a refrigerator body having a cooling chamber therein;
a door configured to open and close the cooling chamber; and
a lighting apparatus,
wherein the lighting apparatus comprises:
a lighting module having one or more light emitting devices, and having a circuit board to make the one or more light emitting devices emit light; and
a waterproofing structure configured to accommodate the lighting module therein.

12. The refrigerator having a lighting apparatus of claim 11, wherein the water-proofing structure comprises:
a case having an accommodation space therein; and
a cover configured to hermetically seal the case.

13. The refrigerator having a lighting apparatus of claim 12, wherein the water-proofing structure is provided with a transparent window.

14. The refrigerator having a lighting apparatus of claim 11, wherein the one or more light emitting devices are implemented as light emitting diodes.
